(19) United States
(12) Patent Application Publication
(10) Pub. No.: US 2007/0196625 A1
(43) Pub. Date: Aug. 23, 2007

(54) Method and apparatus for secure object labeling

(76) Inventors: Daryl E. Anderson, Corvallis, OR (US); Eric T. Martin, Corvallis, OR (US); Andrew L. Van Brocklin, Corvallis, OR (US); Andrew Koll, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/358,991

(22) Filed: Feb. 21, 2006

(51) Int. Cl. B44C 1/26; B32B 3/00

(52) U.S. Cl. 428/172; 428/156; 428/67

(57) ABSTRACT

This invention relates to a label having improved security, comprising: a label substrate having a recessed portion; a layer of an energy activated material substantially located along a section of the recessed portion; and an optically transparent cover located substantially over the energy activated material such that the cover is substantially located within the recess.

### BACKGROUND OF THE INVENTION

1. Field of the Invention

This invention relates to a label having improved security, comprising: a label substrate having a recessed portion; a layer of an energy activated material substantially located along a section of the recessed portion; and an optically transparent cover located substantially over the energy activated material such that the cover is substantially located within the recess.

2. Description of the Related Art

Prior to the present invention, as set forth in general terms above and more specifically below, it is known, to mark an object, such as with an identification tag, and then laminate a protective coating over the mark an order to prevent forging or counterfeiting of the mark. It is also known to mark an object by engraving/etching the object was a special tool. It is further known to mark an object by placing a coating upon the object. The coating may then the covered by a further protective coating in order to prevent forging or counterfeiting of the mark. Finally, it is known to employ laser marking or heating activation (UV or IR heating) in order to mark an object. This laser marking or heated activation coating may also be covered by a protective coating in order to prevent forging or counterfeiting of the mark. While these various techniques are capable of marking an object, they may be time-consuming, sloppy, subject to removal or defacing, and require special tools. Consequently, a more advantageous system, then, would be provided if the mark could be easily made on the object without the use of special tools such that removal or defacing could be prevented.

It is apparent from the above that there exists a need in the art for a method and apparatus for easily marking an object in a way that tampering is prevented, or if it occurs, is obvious. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a label having improved security, comprising: a label substrate having a recessed portion; a layer of an energy activated material substantially located along a section of the recessed portion; and an optically transparent cover located substantially over the energy activated material such that the cover is substantially located within the recess.

In certain preferred embodiments, the energy activated material is further comprised of any suitable material upon which a mark is created when an energy source, such as a laser beam, or heat activation source (UV or IR) impinges the material. Also, the optically transparent cover is further comprised of any suitable UV curable acrylate.

In another further preferred embodiment, the label having improved security can be easily made without the use of special tools such that removal or defacing can be prevented.

The preferred label, according to various embodiments of the present invention, offers the following advantages: improved security; ease of manufacture; improved removal/tampering prevention; and removal/tampering detection. In fact, in many of the preferred embodiments, these factors of improved security, ease of manufacture, improved removal/tampering prevention, and removal/tampering detection are optimized to an extent that is considerably higher than heretofore achieved in prior, known labels.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a side view of a secure object label, according to one embodiment of the present invention; and

FIG. 2 is a top view showing the secure label applied to an object and marked, according to another embodiment of the present invention.

### DETAILED DESCRIPTION OF THE INVENTION

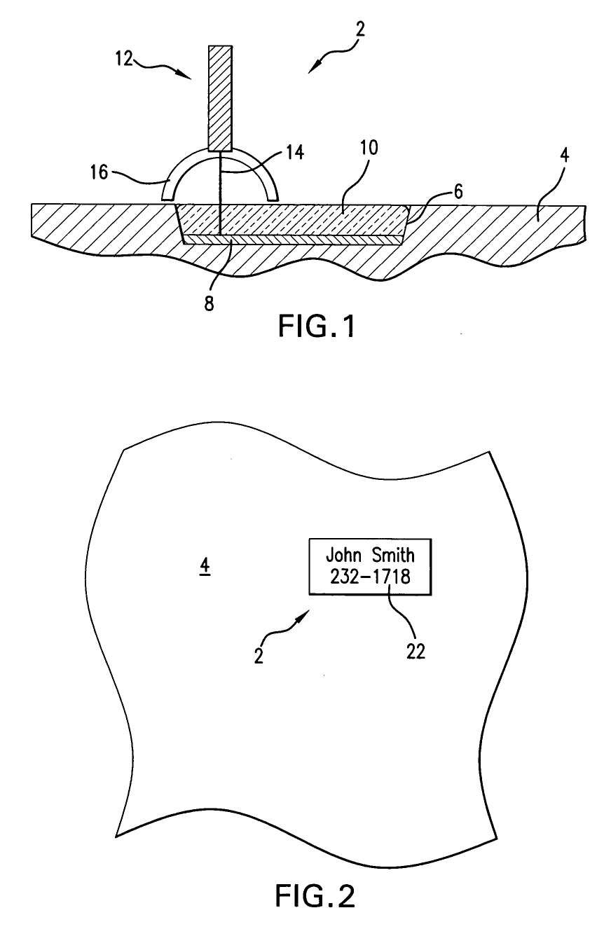

With reference first to FIG. 1, there is illustrated one preferred embodiment for use of the concepts of this invention. As shown in FIG. 1, label 2 is illustrated. Label 2 includes, in part, object 4, label recess 6, energy activated material layer 8, optically transparent cover 10, marking engine 12, energy beam 14, and standoffs 16. Preferably, label recess 6 is conventionally constructed within object 4. Energy activated material layer 8 is then conventionally placed within label recess 6, such as by screen printing. Preferably, energy activated material 8 is any suitable material that creates a mark when a light source or heat activation source (UV or IR) is impinged upon the material, such as laser writable material. In this manner, the light or heat activation source can be accurately operated in order to create precise marks in energy activated material layer 8. Optically transparent cover 10 is conventionally placed over energy activated material layer 8, such as by screen printing. Preferably, optically transparent cover 10 is any suitable UV curable acrylate that is capable of allowing energy beam 14 to be transmitted through it and interact with energy activated material layer 8. It is to be understood that optically transparent cover 10 should also reside within label recess 6. Finally, it is to be understood that the thicknesses of the energy activated material layer 8 and optically transparent cover 10 can be varied as long as the thickness combination of the layer 8 and the cover 10 does not extend outside of recess 6. However, in one embodiment, recess 6 is approximately 2 mm in depth, energy activated material layer 8 thickness is approximately 6 microns, and optically transparent cover layer 10 thickness is approximately 9 microns.

During the construction of label 2, marking engine 12 is activated to create energy beam 14. Preferably, marking engine 12 is a conventional laser light source that is capable of producing a laser beam 14. Also, marking engine 12 can be a conventional UV or IR heat activation source. Standoffs 16 are utilized to maintain a desired distance between marking engine 12 and energy activated material layer 8. As energy beam 14 impinges upon energy activated material layer 8, selective markings 22 (FIG. 2) are created.

With respect to FIG. 2, a top view of label 2 located upon object 4 is illustrated. As discussed above, as energy beam 14 impinges upon energy activated material layer 8, selective markings 22 are created. In this case, the selective markings include the name and telephone number of the owner of object 4. It is to be understood that the content of selective markings 22 and the size of label 2 can be adjusted to accommodate whatever information is desired to be contained within label 2.

With respect to label 2, the optically transparent cover 10 prevents removal of the selective markings 22. Also, optically transparent cover 10 prevents selective markings 22 from being marred. It is to be understood that while selective markings 22 may be blackened out or added to, these markings cannot be erased once they have been created. In this manner if someone attempts to erase selective markings 22, the markings 22 may become illegible. Finally, energy beam 14 allows the user to create extremely small marks. In this manner, a lot of detail can be placed in a small area on object 4.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A label having improved security, comprising:
a label substrate having a recessed portion;
a layer of an energy activated material substantially located along a section of the recessed portion; and
an optically transparent cover located substantially over the energy activated material such that the cover is substantially located within the recess.

2. The label, as in claim 1, wherein the energy activated material is further comprised of:
any suitable material that creates a mark when an energy source is impinged upon the material.

3. The label, as in claim 1, wherein the optically transparent cover is further comprised of:
any suitable UV curable polymeric material that is capable of allowing a energy beam to be transmitted through it and interact with energy activated material layer.

4. The label, as in claim 3, wherein the optically transparent cover is further comprised of:
a UV curable acrylate.

5. The label, as in claim 2, wherein the label is further comprised of:
markings located on the energy activated material such that the markings are created when the energy source is impinged upon the material.

6. The label, as in claim 1, wherein the recessed portion is approximately 2 mm in depth.

7. The label, as in claim 1, wherein a thickness of the energy activated material layer is approximately 6 microns.

8. The label, as in claim 1, wherein a thickness of the optically transparent cover is approximately 9 microns.

9. The label, as in claim 2, wherein the energy source is a laser.

10. The label, as in claim 2, wherein the energy source is a UV heat activation source.

11. The label, as in claim 2, wherein the energy source is an IR heat activation source.

12. A method for making a label having improved security, comprising:
creating a recessed portion in an object to be labeled;
placing a layer of a light-activated material substantially located along a section of the recessed portion; and
placing an optically transparent cover located substantially over the energy activated material such that the cover is substantially located within the recessed portion.

13. The method, as in claim 12, wherein the energy activated material placing step is further comprised of:
screen printing the layer of energy activated material within the recessed portion.

14. The method, as in claim 12, wherein the optically transparent cover placing step is further comprised of:
screen printing the optically transparent cover over the energy activated material.

15. The method, as in claim 12, wherein the method is further comprised of:
impinging a energy beam upon the energy activated material layer to create selective markings.

16. A system for making a label having improved security, comprising:
means for creating a recessed portion in an object to be labeled;
means for placing a layer of a light-activated material substantially located along a section of the recessed portion; and
means for placing an optically transparent cover located substantially over the energy activated material such that the cover is substantially located within the recessed portion.

17. The system, as in claim 16, wherein the energy activated material placing means is further comprised of:
means for screen printing the layer of energy activated material within the recessed portion.

18. The system, as in claim 16, wherein the optically transparent cover placing means is further comprised of:
means for screen printing the optically transparent cover over the energy activated material.

19. The system, as in claim 16, wherein the system is further comprised of:
means for impinging a energy beam upon the energy activated material layer to create selective markings.
